(19) United States
(12) Patent Application Publication
(10) Pub. No.: US 2021/0112045 A1
(43) Pub. Date: Apr. 15, 2021

(54) CLOUD RETRIEVAL APPLICATION

(71) Applicants: Alexander Anatol Siemienczuk, Glassboro, NJ (US); Ezan Marlon Kodjo, Milford, NJ (US)

(72) Inventors: Alexander Anatol Siemienczuk, Glassboro, NJ (US); Ezan Marlon Kodjo, Milford, NJ (US)

(21) Appl. No.: 17/069,601

(22) Filed: Oct. 13, 2020

Related U.S. Application Data
(60) Provisional application No. 62/914,670, filed on Oct. 14, 2019.

(51) Int. Cl. H04L 29/06; H04L 29/08

(52) U.S. Cl. CPC H04L 63/083; H04L 63/0853; H04L 67/02; H04L 63/102; H04L 63/0815

(57) ABSTRACT

A smartphone user-established account in a web accessible database where phone access information can be stored and retrieved in the event the smartphone is lost or stolen or becomes inoperative.

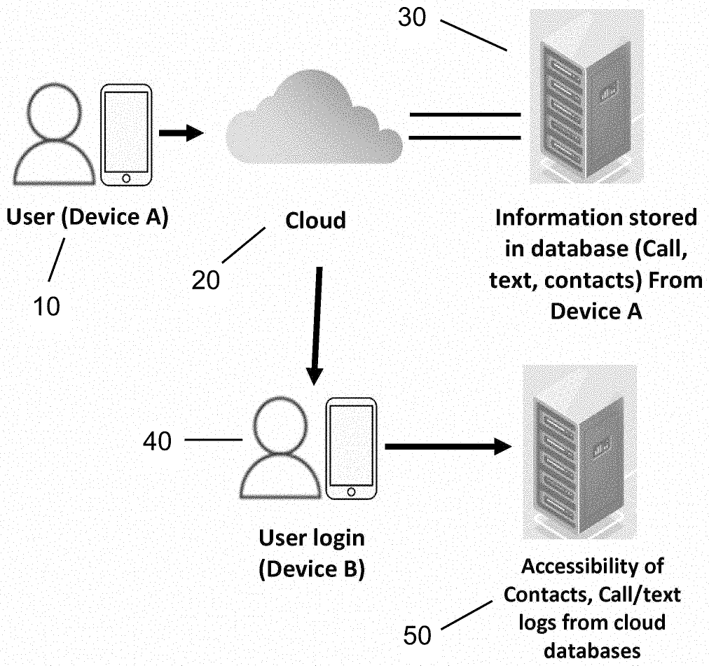

### BACKGROUND OF THE INVENTION

### 1. Field of the Invention

The present invention relates to retrieval of information stored remotely.

### 2. Brief Description of the Prior Art

Smartphones are ubiquitous. Within a remarkably short time, user activities that required significant effort and sometimes copious amounts of personal time, such as access to current news and information, access to documents and books stored in physical libraries, recreational activities such as viewing sports, motion pictures, browsing the Internet, and the like, have found a new, nearly universal platform: the smartphone. At the same time, the smartphone has fueled the rise of social media, which for better or worse, now constitutes a major interest for untold numbers of individuals worldwide. As technology continues to race ahead, the smartphone becomes ever more capable, and ever more important and central to the lives of many.

The magic comes at a price. The most obvious being the cost of the physical phone itself, which can now range over a thousand dollars. Also unavoidably necessary is access to the internet, either through the cell phone radio network or through Wi-Fi or the like, again a problem that can usually be solved by paying for a subscription to a local cell phone carrier. The obverse of the extreme value a user finds in her smartphone is her concomitant dependence of this tool. A dead battery, a phone dropped on a hard surface or into a pool of water, a stolen phone, a lost phone—all mean the loss of the access, which may be a genuine crisis. This is especially true when the individual losing access in this way has stored important information on the in operative or missing smartphone, such as contact lists, browser bookmarks, email, and the like. When access is lost to the information on that phone, there is a substantial, and sometime critical, need to restore the information as quickly as possible.

### SUMMARY OF THE INVENTION

The present invention provides a method for recovering lost access information for a user's portable device, the method comprising creating an account for the user on a web accessible database and storing access information for* a portable device on the web accessible database. The access information preferably includes a user name, password, personal phone number, and email address. The method also preferably includes providing the user with a verification code, as well as reading the verification code submitted by the user when the user accesses the database, such as when the user first accesses the database. The method further preferably includes, providing the user with the opportunity to upload the user's contacts to the database. The user can then upload information the user would like to have access to in the event of loss of the user's portable device, such as the user's contacts. Preferably, the method further comprises providing the user, upon submission of proper credentials, the opportunity for a predetermined period for the user to download the user's access information stored in the database. Preferably, the method also provides the opportunity for the user to download access information requested by the user to another device.

In one aspect of the method of the present invention, the user's portable device is a cell phone or smartphone. In another aspect of the present invention, the user's portable device is a laptop computer.

Preferably, the proper credentials required by the present method include a user name and password. Preferably, the access information provided by the present method includes user names and passwords.

In another aspect, the present invention provides a smartphone application that can be down loaded by a user from a source such as Google Play or the Apple Store, the smartphone application being provided with the functionality required for the user to be able to initiate the method of the present invention. In another aspect, the present invention provides a web-enabled database for implementing the method of the present invention.

### BRIEF DESCRIPTION OF THE DRAWING

The FIGURE is a schematic flow chart showing aspects of the method of the present invention.

### DETAILED DESCRIPTION

The present invention provides a method for recovering lost access information for a user's portable device. Losing access information can be devastating. While good practice with using any computer-enable device, such as a smartphone or a laptop or desktop computer, suggests making secure duplicates of critical information, such as access in formation, the amount of information required to maintain access has for many individuals become staggering. Users are constantly being prompted for access information, such as user names and passwords, while attempting to carry out even routine tasks on their devices. Various approaches have been attempted to address the concomitant problems. For example, most web browsers provide an autocomplete facility, so that websites which are frequently visited and which require predefined information before permitting access, can be accessed by the user without reentry of the required access information by the user. As web threats from malicious sources continue to proliferate, the amount and nature of access information continues to increase. For example, two level authentication can require not only a user name and password, but also the facility to receive an authentication code from a remote site, thus requiring a phone number, email address, or messaging application, for receiving the authentication code. Another popular approach is the password vault application, in which passwords and related information are stored as well as a record of a user's devices, so that access information is retrieved from the vault and delivered to the user's device prior to attempting to access a password-protected website. This has the advantage that the user need not choose memorable passwords, and instead opt for highly secure passwords, optionally originated by the vault software. This solution often does have a major drawback in that a master password or other information may be required to access the vault and the master password, which may not be needed to be used frequently, may be lost or forgotten. Further, a user may be dependent on a single device. While many individuals may have access to a variety of devices, there are large numbers of individuals who prefer to access the on line world through a single device, and for whom the password vault can fail to provide access in the event of the loss, theft or destruction of their single device.

The present invention provides a solution to the problems stemming from loss of access to a smartphone or similar device. In particular, the present invention provides a method for recovering lost access information for a user's portable device. The method includes a series of steps. The first step entails creating an account for a user on a web accessible database. Typically, a potential user will respond to advertising or other sources of information concerning the availability of registering or creating an account on a pre-established web accessible database. Once registration has been accomplished and an account has been created, the user is permitted to upload the user's access information, such as a cell phone number, one or more user names, one or more passwords, the identity of the user's cell service provider, the user's contact list information stored on the user's cell phone, and/or sundry related information, including whatever access information is required by the user's cell service provider to reestablish the user's account on the same or a new cell phone. The method further includes the step of storing access information for the user's portable device on the web accessible database. The user's access information can include a user name, password, personal phone number, and email address. The method also includes providing the user with a verification code, which the user is required to submit to the web-accessible database in order to obtain and use the stored access information. The method also optionally includes providing one or more additional levels of securing, such as creating one or more challenge questions for an individual attempting to use the validation code to obtain the access information, and/or a two-level authentication scheme, or the like. The method further includes reading the verification code submitted by the user when the user first accesses the database, and providing the user with the opportunity to upload the user's contacts and/or access information to the database. The method also includes the step of providing to the user, upon submission of proper credentials, the opportunity to download the user's access information stored in the database. The opportunity may be provided only for a predetermined period, in order to avoid access of the information on an insecure device such as a public computer. The method also includes down loading access information requested by the user to another device, chosen by the user. In one aspect of the method of the present invention, the user's portable device is a cell phone. In another aspect, the user's portable device is a laptop computer. In another aspect, the proper credentials in elude a user name and password. In one embodiment of the present method, the access information includes website user names and passwords.

The method of the present invention is illustrated schematically in the FIGURE. The user using a first device A 10 uploads his or her access information to the “cloud,” that is, the internet 20, and the information is stored in a web-accessible database 30. Assuming the device 10 becomes lost, stolen or inoperable, the user then can log in from a second device 40, permitting the user to access the previously stored information on a web accessible database 50. Note that web accessible database 50 may be the same as web accessible database 30, or a database specially adapted for providing the necessary access information.

Further, the present invention also provides a smartphone application permitting a user to remotely store access information pursuant to the method of the present invention, as well as a web-enabled database for implementing the method.

Various modifications can be made in the details of the various embodiments of the method of the present invention, all within the scope and spirit of the invention as defined by the appended claims.

1. A method for recovering lost access information for a user's portable device, the method comprising:
creating an account for the user on a web accessible database;
storing access information for a portable device on the web accessible database, the access information including a user name, password, personal phone number, and email address;
providing the user with a verification code;
reading, the verification code submitted by the user when the user first accesses the database;
providing the user with the opportunity to upload the user's contacts to the database;
providing the user, upon submission of proper credentials, the opportunity for a predetermined period to download the user's access information stored in the database; and
downloading access information requested by the user to another device.

2. A method according to claim 1 wherein the user's portable device is a cell phone.

3. A method according to claim 1 wherein the user's portable device is a laptop computer.

4. A method according to claim 1 wherein the proper credentials include a user name and password.

5. A method according to claim 1 wherein the access information includes website user names and passwords.

6. A smartphone application permitting a user to remotely store access in formation pursuant to the method of claim 1.

7. A web-enabled database for implementing the method of claim 1.
